(19) United States
(12) Patent Application Publication
(10) Pub. No.: US 2014/0116946 A1
(43) Pub. Date: May 1, 2014

(54) USE OF MULTIVALENT INORGANIC ADDITIVES

(71) Applicant: Syncrude Canada LTD. in trust for the owners of the Syncrude Project as such owners exist now, Fort McMurray (CA)

(72) Inventors: RANDY MIKULA, Edmonton (CA); BARRY BARA, Edmonton (CA); JAMES LORENTZ, Fort McMurray (CA); NAN WANG, Edmonton (CA)

(73) Assignee: SYNCRUDE CANADA LTD. in trust for the owners of the Syncrude Project as such owners of exist now, Fort McMurray (CA)

(21) Appl. No.: 14/014,116

(22) Filed: Aug. 29, 2013

Related U.S. Application Data
(60) Provisional application No. 61/718,868, filed on Oct. 26, 2012.

(51) Int. Cl. C02F 9/00

(52) U.S. Cl. CPC C02F 9/00
USPC 210/663

(57) ABSTRACT

A process of dewatering tailings such as fluid fine tailings from oil sand extraction is provided comprising mixing the tailings with a sufficient amount of an additive comprising at least one multivalent cation, each multivalent cation being in an amount ranging from about 0.125% to about 0.25% and higher, up to or greater than the solubility limit of the at least one multivalent cation, and depositing the resulting mixture into a containment area to yield a non-segregating, rapidly cracking and dewatering deposit for reclamation and recycle water which can optionally be used in an oil sand bitumen extraction process.

### FIELD OF THE INVENTION

The present invention relates to use of multivalent inorganic additives to improve dewatering of tailings and, in some instances, the chemistry of released (recycle) water which can optionally be used in an oil sand bitumen extraction process.

### BACKGROUND OF THE INVENTION

Oil sand generally comprises water-wet sand grains held together by a matrix of viscous heavy oil or bitumen. Bitumen is a complex and viscous mixture of large or heavy hydrocarbon molecules which contain a significant amount of sulfur, nitrogen and oxygen. The extraction of bitumen from sand using hot water processes yields large volumes of tailings composed of fine silts, clays and residual bitumen which have to be contained in a tailings pond.

After a few years when the fine tailings have reached a solids content of about 30-35 wt %, they are sometimes referred to as mature fine tailings. For this discussion we shall use the more general term of fluid fine tailings (FFT) which encompasses the spectrum of tailings from discharge to final settled state. The fluid fine tailings behave as a fluid colloidal-like material. The fact that fluid fine tailings behave as a fluid and have very slow consolidation rates limits options to reclaim tailings ponds. Thus, for the purposes of the present application, fluid fine tailings (FFT) are defined as tailings having a solids content greater than 1 wt % and a shear strength of less than 5 kPa.

A challenge facing the industry remains the removal of water from the fluid fine tailings to increase the solids content well beyond 35 wt % and strengthen the deposits to the point that they can be reclaimed and no longer require containment. In order to remove the water, which may be recycled to the extraction process, the clay structure of the FFT must be modified without affecting the overall recycle water chemistry to the detriment of the extraction process.

While drying, the FFT must retain a network of channels or pore spaces through which the water may drain. Many tailings treatment technologies rely upon polymers which allow for the formation of flocs that create such a network for dewatering. Consolidated (composite) tailings, centrifugation, thin lift dewatering, and rim ditching all require chemical modification of the clay structure to optimize dewatering. Composite (consolidated) tailings are produced by mixing tailings sand, gypsum and FFT to create a mixture which consolidates and releases additional water. Minimal amounts of chemical additives are included in order to create a fines matrix which can be consolidated by the weight of the sand tailings that are added to the mixture at proportions three to seven times greater than the fines content. Centrifugation of polymer-treated FFT is used to separate the water from the clays. Thin lift tailings treatment involves creating a FFT-polymer solution which is deposited in thin layers on a horizontal surface and allowed to dry. Rim ditching involves use of a FFT-polymer solution which is deposited in a containment area. The pressure of the material above helps to squeeze water out of the deposit. When enough strength is created in the clay suspension, a continuous ditch is created around the edge of the deposit to allow for accumulation of the water pushed from the pore spaces, which is collected and removed. However, the efficiencies of chemical additives or polymers require ideal mixing conditions which may be problematic to achieve.

Accordingly, there is a need for an improved method of dewatering tailings and producing recycle water having acceptable chemistry.

### SUMMARY OF THE INVENTION

The current application is directed to the use of multivalent inorganic additives to improve dewatering of tailings and, in some instances, to improve the chemistry of release (recycle) water. The present invention is particularly useful with, but not limited to, fluid fine tailings. It was surprisingly discovered that by conducting the process of the present invention, one or more of the following benefits may be realized:

(1) multivalent inorganic additives having alkaline pH can be mixed with tailings at concentrations approaching or exceeding the solubility limits to accelerate dewatering of the tailings through enhanced consolidation and drying in the rim ditching process without the need for a sand component; and (2) release water having a chemistry amenable to bitumen extraction is produced, and can be reused accordingly without the need for further treatment. Surprisingly, with the right proportion of various additives, the release water can have a lower total dissolved solids concentration compared to that of water recovered from untreated tailings, along with a beneficially modified sodium absorption ratio or exchangeable sodium percentage.

Thus, use of the present invention provides a deposit trafficable for reclamation and may produce release water that is more amenable for use as recycle water in bitumen extraction, thereby reducing fluid tailings accumulation and fresh water demand.

In one aspect, a process for improving dewatering of tailings or the chemistry of recycle water or both is provided, comprising:
mixing the tailings with a sufficient amount of an additive comprising at least one multivalent cation, each multivalent cation being in an amount ranging from about 0.125% to about 0.25% and higher, up to or greater than the solubility limit; and
depositing the resulting mixture into a containment area to yield a non-segregating, rapidly cracking and dewatering deposit for reclamation and recycle water which can optionally be used in an oil sand bitumen extraction process.

In one embodiment, at least one multivalent cation is a divalent cation. In another embodiment, the at least one multivalent cation is a trivalent cation. In another embodiment, the additive is a mixture of two multivalent cations.

In one embodiment, the recycle water has less total dissolved solids that when no additive is added. In another embodiment, the additive is 0.25% lime. In another embodiment, the additive is a combination of lime and gypsum. In another embodiment, the additive comprises 0.25% lime and 0.25% gypsum.

Thus, the process of the present invention may allow for tailoring reagent addition to improve both dewatering and release water chemistry.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 shows untreated fluid fine tailings (oil sands mature fine tailings (MFT)).

FIG. 2 shows fluid fine tailings (MFT) following treatment with 0.25% lime and 0.25% gypsum.

FIG. 3 shows fluid fine tailings (MFT) at one week following treatment with 0.125% lime and 0.125% gypsum (A); 0.185% lime and 0.185% gypsum (B); and 0.25% lime and 0.25% gypsum (C). (D) is the control where the FFT (MFT) was untreated.

FIG. 4 is a graph depicting the normalized weight of oil sands mature fine tailings (MFT) versus time in hours for MFT treated with 0.25% gypsum (closed triangles) and 0.25% lime (closed squares).

### DETAILED DESCRIPTION OF THE PREFERRED EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

The present invention relates generally to a process of improving the dewatering of tailings and, in many instances, improving the chemistry of recycle water using multivalent inorganic additives. As used herein, the term “tailings” means tailings derived from oil sands extraction operations and containing a fines fraction. The term is meant to include fluid fine tailings (FFT) from tailings ponds (i.e., mature fine tailings (MFT)) and fine tailings from ongoing extraction operations (for example, thickener underflow or froth treatment tailings) which may bypass a tailings pond. In one embodiment, the tailings are primarily FFT obtained from tailings ponds given the significant quantities of such material to reclaim. However, it should be understood that the fine tailings treated according the process of the present invention are not necessarily obtained from a tailings pond, and may also be obtained from ongoing oil sands extraction operations.

As used herein, the term “multivalent” means an element having more than one valence, Valence is defined as the number of valence bonds formed by a given atom. Suitable multivalent inorganic additives may comprise divalent or trivalent cations.

As used herein, the term “divalent” means a valence of two and can form two sigma bonds to two different atoms or one sigma bond plus one pi bond to a single atom. A “divalent cation” is an atom missing two electrons as compared with the neutral atom. Examples of divalent cations include, but are not limited to, calcium (Ca²⁺), magnesium (Mg²⁺), iron (Fe²⁺), barium (Ca²⁺), zinc (Zn²⁺), strontium (Sr²⁺), cadmium (Cd²⁺), manganese (Mn²⁺), cobalt (Co²⁺), and nickel (Ni²⁺). In one embodiment, the additive comprises lime (calcium oxide), slaked lime (calcium hydroxide), and/or gypsum (calcium sulfate dehydrate). Divalent cations increase the coagulation of clay particles.

In one embodiment, the additive comprises a trivalent cation. As used herein, the term “trivalent” means a valence of three. A “trivalent cation” is atom missing three electrons as compared with the neutral atom. Examples of trivalent cations include, but are not limited to, aluminium (Al³⁺), iron (Fe³⁺), chromium (Cr³⁺), manganese (Mn³⁺), cobalt (Co³⁺), titanium (Ti³⁺), gadolinium (Gd³⁺), europium (Eu³⁺), terbium (Tb³⁺), and ytterbium (Yb³⁺).

In one embodiment, the additive comprises alum. As used herein, the term “alum” means any one of a series of isomorphous double salts which are hydrated sulphates of a univalent cation (e.g., potassium, sodium, ammonium, cesium, or thallium) and a trivalent cation. Examples of alum include, but are not limited to, potassium aluminum sulfate dodecahydrate (KAl(SO₄)2.12H₂O); sodium aluminum sulfate (NaAl(SO₄)₂.12H₂O); ammonium aluminum sulfate (NH₄Al(SO₄)₂.12H₂O); chromium potassium sulfate (KCr(SO₄)₂.12H₂O); and aluminum sulfate (Al₂(SO₄)₃.18H₂O).

In one embodiment, the additive has an alkaline pH. Hot water bitumen extraction processes are typically conducted under conditions of alkaline pH. Caustic sodium hydroxide at a pH of about 8.5 is used to increase the solubility of asphaltic acids which act as surfactants, promoting the efficiency of bitumen recovery. The additive thus preferably has an alkaline pH to ensure that the recycle water will ultimately have a basic pH amenable to the extraction process.

In one embodiment, the additive is added to the tailings at a concentration approaching or exceeding the solubility limit. As used herein, the term “solubility limit” means the maximum solute concentration which can be dissolved in a solvent at a given temperature.

When the solubility limit is exceeded, the solution is saturated and results in formation of a precipitate. The use of an additive at a concentration approaching or exceeding the solubility limit thus accelerates dewatering without the need for sand, as required for example, in the consolidated (composite) tailings process.

Tailings pond water typically comprises 15-25 mg/mL Ca²⁺ and 5-10 mg/mL Mg²⁺, with a pH of 8.0-8.4 and an alkalinity of about 800-1000 mg/mL HCO³⁻. Total dissolved solids (“TDS”) concentrations are in the brackish range (2000 to 2500 mg/L). As used herein, the term “TDS” means the total amount of salts or metals dissolved in a given volume of water. Dissolved solids are predominantly sodium, bicarbonate, chloride, and sulphate. TDS is used as a common parameter for assessing water quality. High concentrations of TDS in recycle process water are considered detrimental to bitumen recovery through disruption of extraction chemistry, and scaling, corrosion and fouling of equipment.

The preferred additive may be selected according to the tailings composition and process conditions. However, optimum additives have been identified for the effective dewatering of tailings and production of amenable recycle water. In one embodiment, the additive comprises lime (calcium oxide), slaked lime (calcium hydroxide), gypsum (calcium sulfate dihydrate), alum, or combinations thereof.

In one embodiment, the additive comprises a mixture of lime and gypsum. In one embodiment, the mixture comprises lime in a concentration ranging from about 0.125% to about 0.25%, and gypsum in a concentration ranging from about 0.125% to about 0.25%. In one embodiment, the concentrations of lime and gypsum are the same. In one embodiment, the mixture comprises 0.125% lime and 0.125% gypsum. In one embodiment, the mixture comprises 0.185% lime and 0.185% gypsum. In one embodiment, the mixture comprises 0.25% lime and 0.25% gypsum.

Without being bound by theory, the mixture of lime and gypsum may modify the clay structure of the tailings and improve the overall chemistry and quality of the release water. For example, the addition of calcium ions (Ca²⁺) (e.g., through treatment with lime and/or gypsum) promotes flocculation of the clay particles and improvement of the non-segregating behaviour of the tailings (i.e., an increase in viscosity and yield stress). For example, with slaked lime (calcium hydroxide), the following reaction may occur:

Ca(OH)₂+2Clay−Na→(Clay)₂Ca+NaOH (1)

The sodium hydroxide produced in the reaction partly contributes to the basic pH of the release water, making it amenable for reuse in bitumen extraction.

In addition, the use of slaked lime also promotes the precipitation of calcite from solution through the following equation:

Ca(OH)₂+CO₂→CaCO₃↓+H₂O (2)

These reactions are a simplification of a complex set of reactions that include the following:

CaSO₄.2H₂O→Ca²⁺+SO₄²⁻+2H₂O (3)

Ca(OH)₂→Ca²⁺+2OH⁻ (4)

Ca²⁺+2ClayNa→(Clay)₂Ca+2Na⁺ (5)

2HCO₃⁻+2OH⁻→2CO₃²⁻+2H₂O (6)

2Ca²⁺+2CO₃²⁻→CaCO₃↓ (7)

The net effect of all these can be written as:

CaSO₄.2H₂O+Ca(OH)₂+2HCO₃⁻→SO₄²⁻+CaCO₃↓+2H₂O (8)

Gypsum prevents segregation. Addition of gypsum (calcium sulfate dihydrate) increases both calcium and sulphate in the release water. As discussed above, calcium undergoes ion exchange interactions with the clay in the tailings. Sulphate is a conservative ion and increases directly in relation to the amount of gypsum added. Gypsum addition also increases the concentration of sodium due to the calcium ion exchange with sodium on the clay surfaces, thereby modifying the sodium absorption ratio or exchangeable sodium percentage. As used herein, the term “sodium absorption ratio” means a measure of the relative preponderance of dissolved sodium in water compared to the amounts of dissolved calcium and magnesium. As used herein, the term “exchangeable sodium percentage” is the amount of sodium held in exchangeable form. While calcium ions favour flocculation, sodium ions favour dispersion. The mixture of lime and gypsum in the correct proportions can surprisingly also reduce the TDS in the release water by precipitation of calcite.

In one embodiment, the method of the present invention is suitable for use in rim ditching applications. Rim ditching is commonly known to those skilled in the art and will not be discussed in detail. A retaining impoundment is typically constructed in a mined-out pit. The impoundment is of a sufficient size to retain the treated tailings, and may be about 50 m to about 100 m in length, about 50 m to about 100 m in width, and about 10 m to about 30 m in depth. Water removal may be enabled and actively managed via decant structures and rim ditching.

The tailings are initially transferred into a suitable mixing apparatus including, but not limited to, an agitated feed tank, static mixer, and dynamic mixer. A sufficient amount of additive or a mixture of additives is added to the tailings to accelerate the dewatering of tailings and produce amenable recycle water. The additive may be introduced into the in-line flow of the tailings at a line prior to entering the mixing apparatus. As used herein, the term “in-line flow” means a flow contained within a continuous fluid transportation line such as a pipe or another fluid transport structure which preferably has an enclosed tubular construction. Mixing is conducted for a sufficient duration in order to allow the tailings and additive to combine properly and to ensure the efficiency of the additive.

The treated tailings are then deposited into the impoundment where evaporation and drainage of the water occurs. In one embodiment, the deposit may be greater than about 2 m in depth. When the evaporation rate from the tailings deposit exceeds the rate of water release, a crust forms on top of the deposit. The additive treatment causes the formation of cracks in the crust and throughout the interior of the deposit, thereby increasing the surface area for evaporation and providing a network of cracks or channels through which the water may drain and be recovered. The extent and depth of the cracking can be controlled by the amount and proportions of the divalent inorganic salts added to the FFT. These proportions are also controlled in order to ensure that the released water may then be returned to the extraction process. Once the deposited tailings have eventually dried and appears to have a suitable density to allow load-bearing, the deposit may be capped or used directly as a trafficable surface for reclamation.

Exemplary embodiments of the present invention are described in the following Examples, which are set forth to aid in the understanding of the invention, and should not be construed to limit in any way the scope of the invention as defined in the claims which follow thereafter. In the following Examples, the fluid fine tailings used were mature fine tailings from existing oil sands tailings ponds having a solids content of about 30-35 wt %.

### EXAMPLE 1

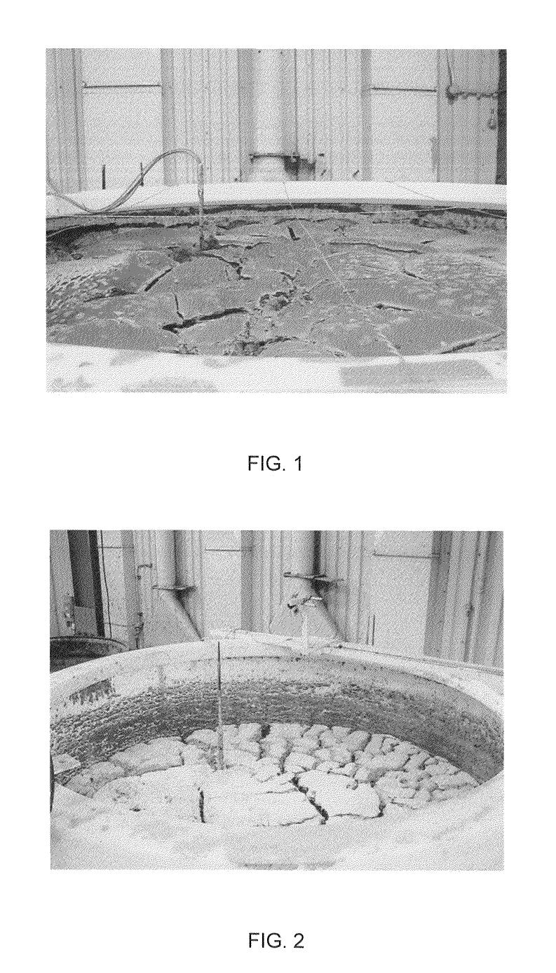

Rim ditching on a laboratory scale was conducted on a sample of fluid fine tailings (FFT) which was placed into a bin. The FFT samples were oil sands mature fine tailings (MFT) having a solids content of about 30-35 wt %. The FFT were treated with 0.25% lime and 0.25% gypsum and compared to untreated FFT which served as a control. The soluble calcium collapsed the clay structure in the treated FFT (FIG. 2), resulting in significant consolidation when compared to the untreated FFT (FIG. 1). As previously mentioned, tailings dewatering relies primarily on two mechanisms, drainage and evaporation. Both of these mechanisms can be enhanced by increasing the cracking in the deposit. Deep cracks, as shown in FIG. 2, provide shorter drainage paths and increase the surface area for evaporation.

### EXAMPLE 2

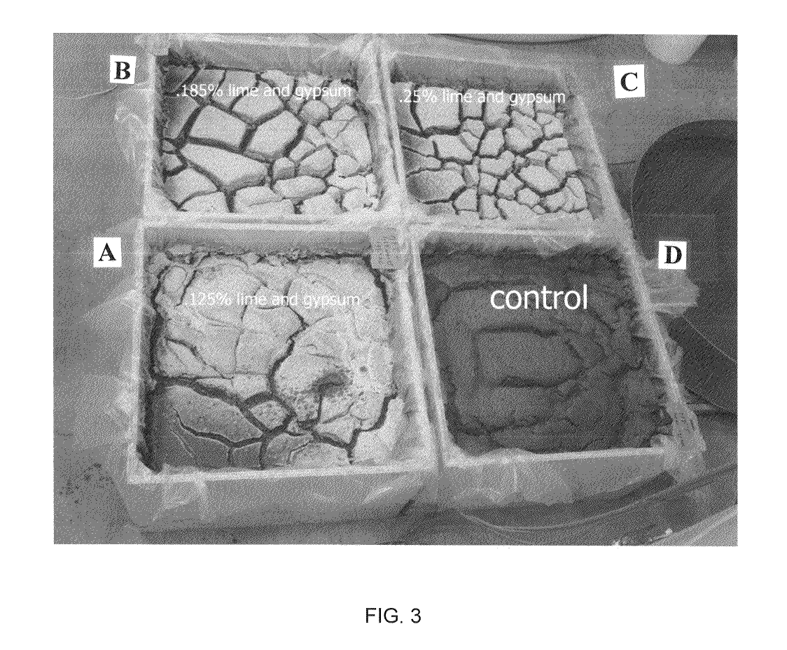

Rim ditching on a laboratory scale was conducted on four samples of FFT which were placed in separate bins as shown in FIG. 3. Three FFT samples were treated with 0.125% lime and 0.125% gypsum (A); 0.185% lime and 0.185% gypsum (B); and 0.25% lime and 0.25% gypsum (C), respectively, and compared to untreated FFT (D) which served as a control. After one week, significant consolidation was observed in the treated FFT samples when compared to the untreated FFT as can be seen in FIG. 3.

### EXAMPLE 3

For water chemistry analyses, the pH and conductivity were measured using a Jenway™ 4330 conductivity and pH meter. Anion content was determined by ion chromatography using a Dionex™-DX 600 series chromatograph with an Ion-Pac™ AS4A-SC analytical column. An inductively coupled argon plasma atomic emission spectrometer (Varian Vista™ RL model ICP-AES) was used to measure individual elements. Carbonate and bicarbonate content were measured using an alkalinity titration titrator (Metrohm Titrino™ Model 751).

The release waters recovered from test bins (A) to (C) in Example 2 were all found to have acceptable water chemistry characteristics (see Table 1 below).

TABLE 1

| | Anion concentration | | | | | Cation concentration | | | | | | |
|---|---|---|---|---|---|---|---|---|---|---|---|---|
| | (mg/L) | | | | | (mg/L) | | | | | Other | |
| Sample ID | Ca | K | Mg | Na | Fe | S | Cl | SO₄ | HCO₃ | CO₃ | pH | Ion balance |
| FFT Dewatering | 329 | 29 | 4 | 1313 | 0 | 855 | 712 | 2446 | 64 | 13 | 8.66 | 1.03 |
| Bin A | | | | | | | | | | | | |
| Release Water | | | | | | | | | | | | |
| (Day 1) | | | | | | | | | | | | |
| FFT Dewatering | 328 | 29 | 5 | 1328 | 0 | 856 | 705 | 2423 | 60 | 15 | 8.71 | 1.05 |
| Bin B Release | | | | | | | | | | | | |
| Water (Day 1) | | | | | | | | | | | | |
| FFT Dewatering | 351 | 34 | 4 | 1336 | 0 | 838 | 708 | 2431 | 63 | 14 | 8.68 | 1.07 |
| Bin C Release | | | | | | | | | | | | |
| Water (Day 1) | | | | | | | | | | | | |
| FFT Dewatering | 330 | 488 | 5 | 1571 | 0 | 1053 | 905 | 3034 | 74 | 8 | 8.51 | 1.08 |
| Bin A Release | | | | | | | | | | | | |
| Water (Day 10) | | | | | | | | | | | | |
| FFT Dewatering | 488 | 39 | 5 | 1721 | 0 | 1133 | 1018 | 3426 | 89 | 0 | 7.85 | 0.99 |
| Bin A Release | | | | | | | | | | | | |
| Water (Day 15) | | | | | | | | | | | | |
| FFT Dewatering | 477 | 39 | 11 | 1687 | 0 | 1118 | 952 | 3178 | 89 | 0 | 7.97 | 1.05 |
| Bin A Release | | | | | | | | | | | | |
| Water (Day 17) | | | | | | | | | | | | |
| FFT Dewatering | 501 | 41 | 6 | 1789 | 0 | 1179 | 1090 | 3594 | 92 | 0 | 7.83 | 0.97 |
| Bin A Release | | | | | | | | | | | | |
| Water (Day 21) | | | | | | | | | | | | |

Table 2 compares the total dissolved solids when fluid fine tailings (oil sands mature fine tailings) are treated with 0.25% lime and the combination of 0.125% gypsum and 0.125% lime. Both treatments showed a decrease in total dissolved solids when compared to the control (no treatment).

TABLE 2

| | Anion concentration | | | | | Cation concentration | | | | | Other | | |
|---|---|---|---|---|---|---|---|---|---|---|---|---|---|
| FFT Pore | (mg/L) | | | | | (mg/L) | | | | | | Ion | Total |
| Waters | Ca | K | Mg | Na | Fe | S | Cl | SO₄ | HCO₃ | CO₃ | pH | balance | dissolved solids |
| Control | 18 | 18 | 13 | 1327 | 0 | 47 | 937 | 135 | 1228 | 251 | 8.4 | 1.0 | 3974 |
| 0.25% | 8 | 12 | 9 | 885 | 3 | 42 | 941 | 48 | 0 | 441 | 10.5 | 0.95 | 2390 |
| Lime | | | | | | | | | | | | | |
| 0.125% | 14 | 13 | 4 | 1159 | 0 | 333 | 964 | 954 | 0 | 0 | 9.4 | 1.1 | 3439 |
| Gypsum, | | | | | | | | | | | | | |
| 0.125% | | | | | | | | | | | | | |
| Lime | | | | | | | | | | | | | |

Table 1 sets out the chemistry for release water produced from 14 m³ test bins of FFT treated with a mixture of 0.25% lime and 0.25% gypsum and sampled at various time points throughout the months of February and March. Table 2 is data from a smaller 0.2 m³ test and compares the chemistry for release water treated with either 0.25% lime alone or a mixture of 0.125% lime and 0.125% gypsum (control—no treatment). In this case the release water chemistry is the average for all of the water (no time dependence to water sample collection).

The results of Tables 1 and 2 show similar trends. Compared to use of lime alone, the addition of gypsum increased the concentrations of calcium, sodium, and sulphate, and decreased the bicarbonate and carbonate concentrations which may normally contribute to water hardness and formation of carbonate scale on extraction equipment. Trace metals such as iron were absent. The data in Table 2 shows that for the right proportion of lime and gypsum, release water chemistry can be controlled to benefit the dewatering process and decrease the total dissolved ions in the water recycled back to the extraction process. Both lime alone and the mixture of lime and gypsum reduced the TDS in the release water. The pH of the release water remained basic which is amenable for bitumen extraction. The ion balance is used to check analytical results. Total anions must be in balance with total cations; thus, the sum of the concentrations of anions should equal the total concentration of cations and the ratio of total anions to total cations should be 1.0.

### EXAMPLE 4

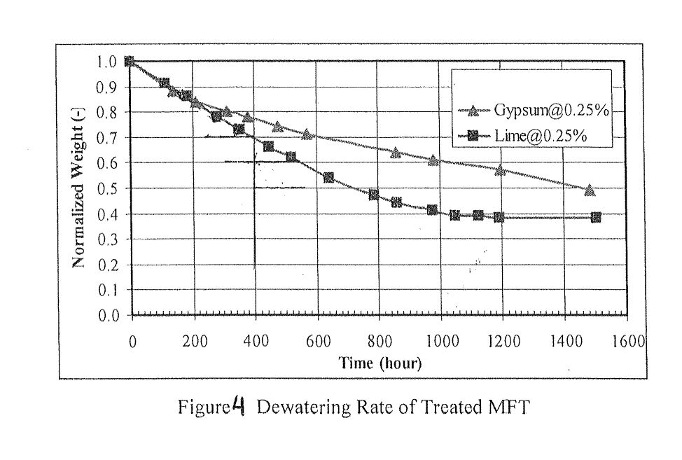

FIG. 4 is a graph depicting the normalized weight of oil sands mature fine tailings (MFT) versus time in hours for MFT treated with 0.25% gypsum (closed triangles) and 0.25% lime (closed squares). FIG. 4 thus depicts the evaporative drying rates of MFT treated with divalent inorganic additives. Both additives were effective in increasing the drying rate of MFT. It should be noted that inorganic additives are superior over other dewatering chemical additives such as polymeric flocculants in that use of same results in lower operation costs and easier handling. For example, it would be possible to re-use gypsum, a by-product of flue gas desulfurization, for MFT treatment.

From the foregoing description, one skilled in the art can easily ascertain the essential characteristics of this invention, and without departing from the spirit and scope thereof, can make various changes and modifications of the invention to adapt it to various usages and conditions. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

We claim:

1. A process of dewatering tailings comprising:
mixing the tailings with a sufficient amount of an additive comprising at least one multivalent cation, each multivalent cation being in an amount ranging from about 0.125% to about 0.25% and higher, up to or greater than the solubility limit of the at least one multivalent cation; and
depositing the resulting mixture into a containment area to yield a non-segregating, rapidly cracking and dewatering deposit for reclamation and recycle water which can optionally be used in an oil sand bitumen extraction process.

2. The process of claim 1, wherein the additive has an alkaline pH.

3. The process of claim 2, wherein the amount of the additive approaches or exceeds the solubility limit.

4. The process of claim 1, wherein the at least one multivalent cation is a divalent cation.

5. The process of claim 1, wherein the at least one multivalent cation is a trivalent cation.

6. The process of claim 1, wherein the additive comprises lime, slaked lime, gypsum, alum, or combinations thereof.

7. The process of claim 1, wherein the additive comprises lime and gypsum.

8. The process of claim 7, wherein the additive comprises 0.125% lime and 0.125% gypsum.

9. The process of claim 7, wherein the additive comprises 0.185% lime and 0.185% gypsum.

10. The process of claim 7, wherein the additive comprises 0.25% lime and 0.25% gypsum.

11. The process of claim 1, wherein the tailings are fluid fine tailings.

12. The process of claim 1, wherein the pH of the recycle water is alkaline.

13. The process of claim 1, wherein the recycle water has higher concentrations of calcium, sodium, and sulphate compared to those of water recovered from untreated tailings.

14. The process of claim 1, wherein the recycle water has lower concentrations of bicarbonate and carbonate compared to those of water recovered from untreated tailings.

15. The process of claim 1, wherein the recycle water has a lower total dissolved solids concentration compared to that of water recovered from untreated tailings.

16. The process of claim 11, wherein the fluid fine tailings are mature fine tailings obtained from an existing oil sand tailings pond.
